(19) United States
(12) Patent Application Publication
(10) Pub. No.: US 2003/0170391 A1
(43) Pub. Date: Sep. 11, 2003

(54) Coating apparatus and coating method

(75) Inventors: Go Nishino, Shizuoka-ken (JP); Toru Onogawa, Shizuoka-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/378,921

(22) Filed: Mar. 5, 2003

(30) Foreign Application Priority Data
Mar. 6, 2002 (JP) 2002-60025

(51) Int. Cl. B05D 3/12; B05D 3/10; B05D 1/28

(52) U.S. Cl. 427/337; 427/355; 118/407

(57) ABSTRACT

It is an object of the present invention to provide a coating apparatus and a coating method that can effectively prevent thick coating and the like in a bar coater having a coating bar and a fulcrum supporting the coating bar from the below.

The coating apparatus comprising a coating liquid-adhering device for adhering the coating liquid across an entire width of one surface of a continuously travelling belt-shaped body; a coating thickness-adjusting device located downstream from the coating liquid-adhering device with respect to the travelling direction of the belt-shaped body, and adjusting a thickness of a layer of the coating liquid adhered to the belt-shaped body by the coating liquid-adhering device into a predetermined thickness; and a drying-preventative device for preventing the coating liquid at the coating thickness-adjusting device from drying.

### BACKGROUND OF THE PRESENT INVENTION

1. Field of the Present Invention

The present invention relates to a coating apparatus and a coating method, and particularly a coating apparatus and a coating method that can effectively prevent problems from occurring, such as coating liquid drying and leaving a thick coating downstream from a coating bar in a bar coating apparatus and a bar coating method in which a coating liquid is adhered to a belt-shaped body and the coating liquid is measured by a coating bar.

2. Description of the Related Art

Photographic photosensitive materials, printing paper, magnetic recording materials, coated metal sheets, and planographic printing plates are manufactured by coating a coating liquid onto a base material such as a support web.

Bar coaters, slide-bead coaters, extrusion coaters and the like are used to coat the coating liquid. In particular, bar coaters have come to be widely used in view of the ease with which they can be handled.

Conventionally, bar coaters disposed with a coating bar that rotates in the same direction or in the opposite direction with respect to a travelling direction of the base material while contacting a continuously running bottom surface of the base material, and a coating unit that discharges a coating liquid to a part of the base material that is further upstream than the bar coater with respect to the travelling direction of the base material (referred to below simply as “upstream”) to form a coating liquid puddle and coats the bottom surface of the base material with the coating liquid while the base material is travelling, have come to be commonly used as the bar coaters.

A bar coater that includes a first weir plate disposed near a coating bar upstream from the coating bar and formed so that the thickness at an upper end thereof tapers downstream with respect to the travelling direction of a web (referred to below simply as “downstream”), with the upper end of the weir plate bending toward the coating bar and a top of the upper end including a flat surface of 0.1 to 1 mm in width (Japanese Utility Model Application No. 63-126213), and a bar coater that includes a coating bar and a first weir plate formed so that the thickness at an upper end thereof tapers downstream, with a second weir plate being disposed downstream from the coating bar (Japanese Patent Application Publication No. 58-004589), have come to be commonly used.

However, although, the coating liquid is supplied to an upstream side of the coating bar by the coating unit in these conventional bar coaters, the coating liquid is not continuously supplied to a downstream side of the coating bar.

Therefore, a problem may occur, wherein the coating liquid leaks out between the coating bar and a fulcrum supporting the coating bar from below and dries at the downstream side of the coating bar to adhere to the bottom surface of the base material, or mixes with a layer of coating liquid coated onto the base material, to cause defects such as a thick coating.

### SUMMARY OF THE PRESENT INVENTION

It is an object of the present invention to solve the above-described problems. Specifically, it is an object of the present invention to provide a coating apparatus and a coating method, which use a bar coater, and prevent formation of defects such as a thick coating.

In order to achieve the above-described object, a first aspect of the present invention is a coating apparatus for coating a coating liquid onto a continuously travelling belt-shaped body, the coating apparatus comprising: a coating liquid-adhering device for adhering the coating liquid across an entire width of one surface of the belt-shaped body; a coating thickness-adjusting device located downstream from the coating liquid-adhering device with respect to the travelling direction of the belt-shaped body, the coating thickness-adjusting device for adjusting a thickness of a layer of the coating liquid adhered to the belt-shaped body by the coating liquid-adhering device in a predetermined thickness; and a drying-preventative device for preventing the coating liquid at the coating thickness-adjusting device from drying.

In the above-described coating apparatus, the drying-preventative prevents the coating liquid from drying at the coating thickness-adjusting device, and therefore, drying of the coating liquid at the coating thickness-adjusting device and formation of various kinds of defects on a coated surface on the belt-shaped body can be prevented.

There are no particular limitations on the belt-shaped body as long as it is belt-shaped and is a thin sheet-shaped or film-shaped article having flexibility. Specific examples include: an aluminium support web that is a support for a planographic printing plate produced from a thin aluminium sheet and; film bases for photographic recording materials such as photographic film and movie film; baryta paper for printing paper; base material for magnetic recording materials such as polyester film used in magnetic recording materials such as an audio tape, a video tape, and a floppy (R) disc; and thin metal sheets used for coated metal sheets such as an enamelled steel sheet.

The belt-shaped body also includes a tape-shaped body of various kinds of papers such as kraft paper, parchment paper, and polyethylene-coated paper.

The coating surface of the belt-shaped body may be subjected to various processing like graining and anodization as in the support web.

Examples of the coating liquid include: a photosensitive layer-forming liquid and a heat-sensitive layer-forming liquid, both of which are coated onto a support web for a planographic printing plate to form a plate-making layer; an oxidization preventative layer-forming liquid coated on the plate-making layer and containing an oxygen-impermeable resin such as a polyvinyl alcohol as an essential component; a substrate-forming liquid for forming a substrate on the grained surface of the support web for improving adhesion between the support web and the plate-making layer; and various solvents.

Other examples of the coating liquid include: a photosensitive emulsion used for forming a photosensitive layer of a photographic material such as a photographic film, a movie film, and a printing paper; antihalation layer-forming liquid used for forming an antihalation layer in a photographic film and a movie film; and various coating materials used for undercoats, intermediate coats, and top coats of the coated metal sheets mentioned in the above. The coating liquid is not limited to the examples listed above and includes a solution, a suspension, and a solvent that can be coated onto the base material. The viscosity of the coating liquid is preferably 100 mPa/s or less and more preferably 50 mP/s or less. Also, the surface tension is preferably 20 to 70 mN/m.

A different layer may also be formed in advance on the coating surface of the belt-shaped body.

The thickness of the belt-shaped body is ordinarily 0.1 to 1 mm, but is not limited to this range.

A second aspect of the present invention for achieving the above-described object is the coating apparatus of the first aspect wherein the coating thickness-adjusting device is a coating bar disposed downstream of the coating liquid adhering means with respect to the travelling direction of the belt-shaped body, and the drying-preventative device is a downstream liquid-coating device for coating a drying-preventative liquid onto a downstream side of the coating bar with respect to the travelling direction of the belt-shaped body, the drying-preventative liquid for preventing drying of the coating liquid on a coating bar surface.

Because the drying-preventative liquid is coated onto the downstream side of the coating bar by the downstream liquid-coating device in the coating apparatus, drying of coating liquid leaking out between the coating bar and a fulcrum supporting the coating bar is prevented.

Therefore, formation of defects such as thick coating caused by adhesion of a solid substance formed by drying the coating liquid to a coated surface formed by coating the coating liquid on a surface of the belt-shaped body, or by mixing the solid substance into an undried layer of the coating liquid on the coated surface, can be effectively prevented.

The drying-preventative liquid is a liquid that prevents the coating liquid on the coating bar surface from drying. Specifically, examples thereof include the coating liquid itself, a solvent blended into the coating liquid, and a diluted solution in which the coating liquid has been diluted with the solvent. A surfactant and the like can be optionally blended with the drying-preventative liquid.

As long as the downstream liquid-coating device has a function of supplying the drying-preventative liquid to the downstream side of the coating bar, the downstream liquid-coating device is not limited to a downstream coating liquid flow path described later.

Examples of the downstream liquid-coating device include the downstream coating liquid flow path as well as a downstream supply device having a conduit that extends toward the downstream side of the coating bar and supplying the drying-preventative liquid thereto.

Examples of the downstream supply device include a fixed supply device comprising a main body that is tubular and has one of its end closed off, fixed near the downstream side of the coating bar so as to be parallel with the coating bar; and plural drying-preventative liquid-discharging tubes having an open end opening toward a travelling surface of the belt-shaped body and disposed at fixed intervals across the entire length of the main body.

In the fixed supply device, a drying-preventative liquid such as the coating liquid is supplied to the main body and discharged from the open ends of the drying-preventative liquid-discharging tubes to be coated onto the downstream surface of the coating bar.

Other examples of the downstream supply device include a reciprocating liquid supply device having a base disposed with one or more drying-preventative liquid-discharging tubes, and a reciprocating device that reciprocates the base in parallel to the coating bar across the entire length thereof.

In the reciprocating liquid supply device, a drying-preventative liquid such as the coating liquid is supplied to the base and discharged toward the coating bar from the ends of the drying-preventative liquid-discharging tubes.

The coating liquid-adhering device has a function of adhering the coating liquid onto the coating surface of the belt-shaped body upstream from the coating bar. Specific examples thereof include a coating liquid-discharging flow path described later.

An upstream coating liquid flow path can also function as the coating liquid-adhering device.

It is preferable that the coating bar is disposed in a direction orthogonal to the travelling direction of the belt-shaped body.

The diameter of the coating bar is preferably 1 to 25 mm and more preferably 6 to 15 mm. The coating bar may rotate in the direction opposite to, or in the same direction as the travelling direction of the belt-shaped body. The coating bar also can be stationary.

It is preferable that the coating bar is made of metal, in view of strength and abrasion resistance. In particular, the coating bar is preferably made of stainless steel, in view of not only excellent strength and abrasion resistance but excellent resistance to erosion.

The coating bar may be a smooth bar whose surface is formed smooth, a grooved bar having grooves formed in a surface thereof along the circumferential direction, or a wired bar having a wire wrapped around a surface thereof in the circumferential direction.

The grooved bar preferably has grooves having a depth of 0.05 to 1 mm and more preferably, has grooves having a depth of 0.07 to 0.5 mm. The pitch of the grooves is preferably 0.05 to 0.1 mm and more preferably 0.1 to 0.6 mm.

The grooves can have a different cross sectional shape such as a sine curve, a trapezoid, a semicircle, or a triangle.

The diameter of the wire of the wired bar is preferably 0.07 to 1 mm and more preferably 0.07 to 0.6 mm. The material of the wire is preferably metal, in view of erosion resistance and abrasion resistance, and is more preferably, stainless steel.

The surface of the coating bar may be hard chrome-plated in order to further improve abrasion resistance.

In case when the coating bar is rotated in the direction opposite to the travelling direction of the belt-shaped body, the rotational frequency is preferably 200 rpm or less. In case when the coating bar is rotated in the same direction as the travelling direction of the belt-shaped body, it is preferable to rotate the coating bar so that the peripheral velocity is equal to or less than the travelling velocity of the belt-shaped body.

In order to achieve the above-described object, a third aspect of the present invention relates to the coating apparatus pertaining to the second aspect, wherein the coating liquid is used as the drying-preventative liquid.

Since the coating liquid is used as the drying-preventative liquid in the above-mentioned device, the composition of the coating liquid is remained substantially unchanged even if the coating liquid and the drying-preventative liquid mix with each other at the surface of the coating bar.

Therefore, the coating apparatus of the present aspect is particularly preferable when the coating liquid is collected and recycled.

Also, there is no need to provide a conduit for the drying-preventative liquid separate from the conduit for the coating liquid, the piping of the apparatus can be largely simplified.

In order to achieve the above-described object, a fourth aspect of the present invention relates to the coating apparatus of the third aspect, wherein the belt-shaped body is a support web for a planographic printing plate, and the coating liquid is a plate-making layer-forming liquid for forming a plate-making layer on the planographic printing plate.

The coating apparatus of the present aspect is an example of a coating apparatus of the present invention applied to a planographic printing plate producing process. For the same reason as stated in regard to the first aspect, the coating apparatus of the present aspect can effectively prevent a problem such as adhesion of a solid substance formed by drying the plate-making layer-forming liquid adhered to an undried plate-making surface of the support web, or mixing of the solid substance with an undried plate-making layer-forming liquid on the support web, both of which lead to formation of defects such as thick coating.

The plate-making layer-forming liquid may be a photosensitive layer-forming liquid containing a photosensitive resin and used to form a visible light exposure type plate-making layer, or may be a laser photosensitive layer-forming liquid containing heat-sensitive resin or photopolymerizable resin and used to form a laser exposure type plate-making layer.

In order to achieve the above-described object, a fifth aspect of the present invention relates to the coating apparatus of the second aspect, further comprising upstream liquid-coating device for coating the drying-preventative liquid onto an upstream side of the coating bar with respect to the travelling direction of the belt-shaped body simultaneous with coating of the coating liquid.

In order to achieve the above-described object, a sixth aspect of the present invention relates to the coating apparatus of the third aspect, further comprising upstream liquid-coating device for coating the drying-preventative liquid onto an upstream side of the coating bar with respect to the travelling direction of the belt-shaped body simultaneous with coating of the coating liquid.

In order to achieve the above-described object, a seventh aspect of the present invention relates to the coating apparatus of the fourth aspect, further comprising upstream liquid-coating device for coating the drying-preventative liquid onto an upstream side of the coating bar with respect to the travelling direction of the belt-shaped body simultaneous with coating of the coating liquid.

Since the coating liquid is supplied to the upstream side of the coating bar by the upstream liquid-coating device in the coating apparatus of these aspects, drying of the coating liquid adhered to the belt-shaped body by the coating liquid-adhering device can be prevented before a thickness of the layer of the coating liquid on the belt-shaped body is adjusted by the coating bar, even when the coating liquid-adhering device is distantly located from the coating bar.

As well as an upstream coating liquid flow path described later, an upstream coating liquid-adhering device having the same structure as that of the above-mentioned downstream supply device is included in the examples of the upstream liquid-coating device. Specifically, a fixed supply device and a reciprocating adherence device, both of which are mentioned above, are included in the example.

In order to achieve the above-described object, an eighth aspect of the present invention relates to the coating apparatus of the fourth aspect, further comprising a downstream weir member disposed downstream from the coating bar with respect to the travelling direction of the belt-shaped body so as to be parallel with and facing the coating bar, wherein the downstream liquid-coating device is a downstream coating liquid flow path formed between the coating bar and the downstream weir member.

In order to achieve the above-described object, a ninth aspect of the present invention relates to the coating apparatus of the seventh aspect, further comprising a downstream weir member disposed downstream from the coating bar with respect to the travelling direction of the belt-shaped body so as to be parallel with and facing to the coating bar, wherein the downstream liquid-coating device is a downstream coating liquid flow path formed between the coating bar and the downstream weir member.

As the downstream coating liquid flow path having a slit-like shape is formed along the coating bar, the drying-preventative liquid is supplied evenly across the entire length of the coating bar at the downstream side of the coating bar.

Therefore, the coating apparatus of the present aspect is preferable in that there is very little unevenness or defects in the coated surface of the belt-shaped body.

In order to achieve the above-described object, a tenth aspect of the present invention relates to the coating apparatus of the seventh aspect, further comprising an upstream weir member disposed upstream from the coating bar with respect to the travelling direction of the belt-shaped body so as to be parallel with and facing to the coating bar, wherein the upstream liquid-coating device is an upstream coating liquid flow path formed between the coating bar and the upstream weir member.

As the upstream coating liquid flow path has a shape of a slit extending along the coating bar, the drying-preventative liquid is supplied evenly across the entire length of the coating bar at the upstream side thereof.

Therefore, even when the coating liquid-adhering device is distantly located from the coating bar, little unevenness is formed on the coated surface of the belt-shaped body.

In order to achieve the above-described object, an eleventh aspect of the present invention relates to the coating apparatus of the second aspect, wherein the coating liquid-adhering device is a coating liquid-discharging nozzle for discharging coating liquid toward the belt-shaped body, the coating liquid-discharging nozzle opening toward a travelling surface that is a travelling path of the belt-shaped body.

The coating apparatus of the present aspect is preferable in that the coating liquid-adhering device can have a simple structure.

In order to achieve the above-described object, a twelfth aspect of the present invention relates to the coating apparatus of the fifth aspect, wherein the upstream liquid-coating also functions as the coating liquid-adhering device.

The coating apparatus of the present aspect is preferable in that its structure can be simplified because there is no need to dispose upstream liquid-coating device separately from the coating liquid-adhering device.

In order to achieve the above-described object, a thirteenth aspect of the present invention relates to the coating apparatus of the eighth aspect, wherein a gap between the downstream weir member and the coating bar is 0.2 to 12 mm.

In order to achieve the above-described object, a fourteenth aspect of the present invention relates to the coating apparatus of the ninth aspect, wherein a gap between the downstream weir member and the coating bar is 0.2 to 12 mm.

In the coating apparatus of the present aspect, a stable overflow from the downstream coating liquid flow path can be maintained even when the coating liquid has a viscosity of 100 mPa/s or less, and therefore drying of the coating liquid at the downstream side of the coating bar can be effectively prevented.

In order to achieve the above-described object, a fifteenth aspect of the present invention relates to the coating apparatus of the tenth aspect, wherein a gap between the upstream weir member and the coating bar is 0.2 to 12 mm.

A stable overflow from the upstream coating liquid flow path can be maintained in the coating apparatus of the present aspect even when the coating liquid has a viscosity of 100 mPa/s or less. Therefore, the coating liquid coated onto the belt-shaped body by the coating liquid-adhering device drying before the thickness of a layer of the coating liquid is adjusted by the coating bar can be effectively prevented. It is also possible to stably coat the coating liquid onto the belt-shaped body in the coating apparatus wherein the upstream coating liquid flow path functions as the coating liquid-adhering device.

In order to achieve the above-described object, a sixteenth aspect of the present invention relates to the coating apparatus of the thirteenth aspect, wherein the difference between a largest portion and a smallest portion of the gap between the downstream weir member and the coating bar is 0.05 mm or less.

In order to achieve the above-described object, a seventeenth aspect of the present invention relates to the coating apparatus of the fourteenth aspect, wherein the difference between a largest portion and a smallest portion of the gap between the downstream weir member and the coating bar is 0.05 mm or less.

In the coating device of the present aspect, the width of the downstream coating liquid flow path formed by the downstream weir member and the coating bar is highly even, and stable overflow can be maintained in the downstream coating liquid flow path. Therefore, drying of the coating liquid coated onto the belt-shaped body can be effectively prevented.

In order to achieve the above-described object, an eighteenth aspect of the present invention relates to the coating apparatus of the fifteenth aspect, wherein the difference between a largest portion and a smallest portion of the gap between the upstream weir member and the coating bar is 0.05 mm or less.

In the coating apparatus of the present aspect, the width of the upstream coating liquid flow path formed by the upstream weir member and the coating bar is highly even, and stable overflow can be maintained in the upstream coating liquid flow path. Therefore, drying of the coating liquid coated onto the belt-shaped body can be effectively prevented.

In order to achieve the above-described object, a nineteenth aspect of the present invention is a coating method for coating a coating liquid onto a continuously travelling belt-shaped body, the method comprising the steps of: adhering the coating liquid onto the belt-shaped body by a coating liquid-adhering device; adjusting by a coating thickness-adjusting device the thickness of a coating liquid adhered to the belt-shaped body by the coating liquid-adhering device to a predetermined thickness in a portion of the belt-shaped body downstream from the coating liquid-adhering device; and simultaneous with the adjusting step, coating a drying-preventative liquid on the belt-shaped body with a drying preventative device at a downstream side of the coating liquid-adhering device with respect to the travelling direction of the belt-shaped body, the drying-preventative liquid preventing the coating liquid from drying at the coating thickness-adjusting device.

For the same reason as explained on the coating apparatus of the first aspect, the coating method of the present aspect can effectively prevent a problem, wherein the coating liquid dries at the coating thickness-adjusting device and different kinds of defects are formed on the coated surface of the belt-shaped body.

In order to achieve the above-described object, a twentieth aspect of the present invention is the coating method of the nineteenth aspect, wherein the coating thickness-adjusting device is a coating bar that is disposed downstream of the coating liquid adhering means with respect to the travelling direction of the belt-shaped body, and the drying-preventative device is a downstream liquid-coating device for coating a drying-preventative liquid onto a downstream side of the coating bar with respect to the travelling direction of the belt-shaped body.

For the same reason described in the explanation of the coating apparatus of the second aspect, the coating method of the present aspect can effectively prevent the problem, wherein a solid substance formed by drying the coating liquid sticks on a coated surface of the belt-shaped body or mixes into a layer of the coating liquid on the coated surface to cause formation of defects such as thick-coating on the belt-shaped body.

In order to achieve the above-described object, a twenty-first aspect relates the coating method of the twentieth aspect, wherein the drying-preventative liquid is the coating liquid.

As mentioned in the explanation of the coating apparatus of the third aspect, since the coating liquid is employed as the drying-preventative liquid in the coating method of the present aspect, even when the coating liquid is mixed with the drying preventative liquid on the surface of the coating bar, the composition of the coating liquid is kept unchanged. Therefore, the coating method is preferable when the coating liquid is collected and recycled.

In order to achieve the above-described object, a twenty-second aspect relates the coating method of the twenty-first aspect, wherein the belt-shaped body is a support web for a planographic printing plate, and the coating liquid is a plate-making layer-forming liquid for forming a plate-making layer in the planographic printing plate.

The coating method of the present aspect is an example of the coating method of the present invention applied to a planographic printing plate producing process.

As mentioned in the explanation of the nineteenth aspect, the coating method of the present aspect can effectively prevent the problem, wherein a solid substance formed by drying of the coating liquid sticks onto an undried plate-making surface formed on the support web or mixes into an undried layer of the coating liquid to cause formation of defects such as thick coating.

### BRIEF DESCRIPTION OF THE DRAWINGS

FIG. 1 is a cross sectional view showing the schematic structure of a coating apparatus pertaining to a first embodiment;

FIG. 2 is a cross sectional view showing the schematic structure of a coating apparatus pertaining to a second embodiment; and

FIG. 3 is a cross sectional view showing the schematic structure of a coating apparatus pertaining to a third embodiment.

### DESCRIPTION OF THE PREFERRED EMBODIMENTS

First Embodiment

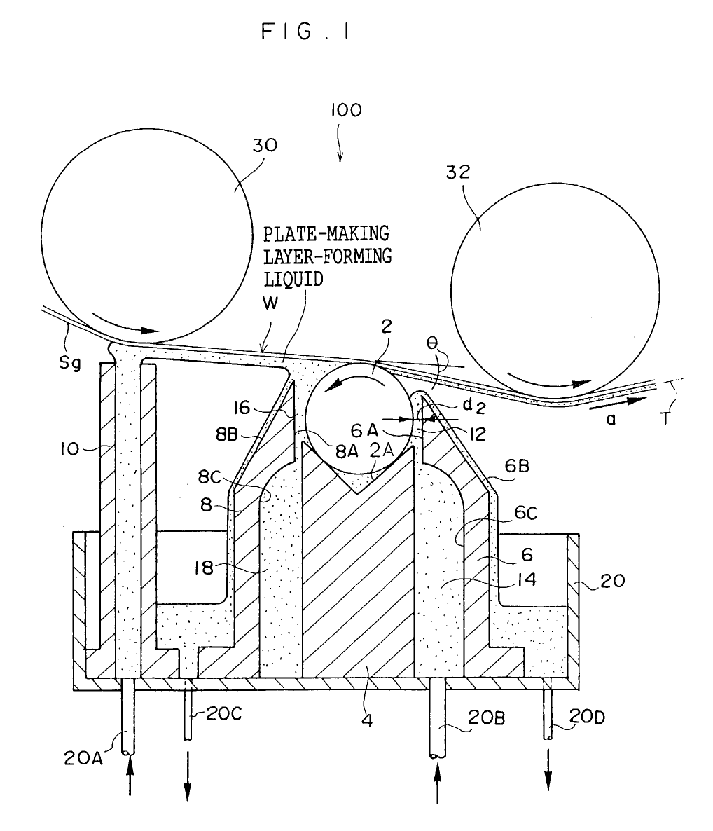

FIG. 1 shows the schematic structure of an example of a coating apparatus pertaining to the present invention.

A coating apparatus 100 pertaining to a first embodiment is an example of a belt-shaped body in the present invention, and is a coating apparatus for coating a plate-making layer-forming liquid, which is an example of a coating liquid in the present invention, onto a support web W, which travels continuously in the direction of arrow ‘a’ in FIG. 1 and is retained so that a grained surface Sg thereof faces downward.

As shown in FIG. 1, the coating apparatus 100 includes a coating bar 2, a fulcrum 4, a downstream weir member 6, an upstream weir member 8, and a coating liquid-discharging nozzle 10. The coating bar 2 is disposed at a direct angle with respect to the travelling direction ‘a’ of the support web W. The fulcrum 4 has, in a top surface thereof, a V-shaped coating bar support groove 2A for supporting the coating bar 2, and is a platy member for supporting the coating bar 2 from below. The downstream weir member 6 is disposed downstream from the fulcrum 4 and the coating bar 2 with respect to the travelling direction ‘a’ so as to be parallel to the coating bar 2 and facing to the coating bar 2 and the fulcrum 4. The upstream weir member 8 is disposed upstream from the fulcrum 4 and the coating bar 2 with respect to the travelling direction ‘a’ so as to be parallel to the coating bar 2 and facing to the coating bar 2 and the fulcrum 4. The coating liquid-discharging nozzle 10 is positioned upstream from the upstream weir member 8 with respect to the travelling direction ‘a’ of the support web W. The coating liquid-discharging nozzle 10 has a slit opening formed in a direction orthogonal to the travelling direction ‘a’, through which slit opening the plate-making layer-forming liquid is discharged upward. The coating liquid-discharging nozzle 10 corresponds to coating liquid-adhering device in the coating apparatus of the present invention.

The distance between the coating bar 2 and the coating liquid-discharging nozzle 10 is preferably 5 to 50 mm and more preferably 15 to 40 mm.

Any of a smooth bar, a grooved bar, and a wired bar can be used as the coating bar 2. As shown in FIG. 1, the coating bar 2 may be driven in the direction opposite to the travelling direction ‘a’ of the support web W, kept stationary, driven in the same direction as the travelling direction ‘a’, or driven by the support web W.

The downstream weir member 6 has a substantially L-shaped cross section, and an upper end thereof bends toward the coating bar 2. At the top of the downstream weir member 6, a vertical surface 6A, which is a vertical surface facing the coating bar 2, is formed on the side facing to the coating bar 2, while on the opposite side, an inclined surface 6B slopes to the downstream with respect to the travelling direction ‘a’. Below the vertical surface 6A, a curved surface curving toward the downstream is formed and a second vertical surface 6C is formed continuously below the curved surface.

A downstream slit 12 corresponding to the downstream coating liquid flow path in the present invention is disposed between the coating bar 2 and the vertical surface 6A. The width of the downstream slit 12 in the travelling direction ‘a’, i.e., a thickness d2, can also be described as the distance between the coating bar 2 and the vertical surface 6A of the downstream weir member 6. The thickness d2 of the downstream slit 12 is preferably 0.2 to 12 mm and more preferably 0.3 to 10 mm.

A coating liquid reservoir 14 is formed continuously below the downstream slit 12, i.e., between the fulcrum 4 and the downstream weir member 6.

The upstream weir member 8 has a substantially inverted L-shaped cross section and is disposed at a position facing to the downstream weir member 6, with the fulcrum 4 being disposed between the upstream weir member 8 and the downstream member 6. The top of the upstream weir member 8 bends toward the coating bar 2.

At the top of the upstream weir member 8, a vertical surface 8A that is a vertical surface facing to the coating bar 2 is formed on the side facing to the coating bar 2, while on the side opposite to the vertical surface 8A, an inclined surface 8B sloping upstream with respect to the travelling direction ‘a’ is formed. A curved surface that curves downstream is formed below the vertical surface 8A, and a second vertical surface 8C is formed continuously below the curved surface.

An upstream slit 16 is formed between the coating bar 2 and the vertical surface 8A.

A coating liquid reservoir 18 is formed continuously below the upstream slit 16, i.e., between the fulcrum 4 and the upstream weir member 8.

The coating liquid-discharging nozzle 10, the upstream weir member 8, the fulcrum 4, and the downstream weir member 6 are all fixed by fixing device (not illustrated) such as a bolt onto a shallow box-shaped base 20 that opens upward.

A first supply tube 20A for supplying the plate-making layer-forming liquid to the coating liquid-discharging nozzle 10 and a second supply tube 20B for supplying the plate-making layer-forming liquid to the coating liquid reservoir 14 are respectively disposed beneath the coating liquid-discharging nozzle 10 and the coating liquid reservoir 14 in a bottom surface of the base 20. A first drainage tube 20C for discharging plate-making layer-forming liquid flowing down between the coating liquid-discharging nozzle 10 and the upstream weir member 8 and a second drainage tube 20D for discharging plate-making layer-forming liquid flowing down between the downstream weir member 6 and a downstream side wall of the base 20 are also disposed in the base 20.

A pressing roller 30 and a pressing roller 32 are respectively disposed downstream and upstream from the coating bar 2 and above a travelling surface T, which is the travelling path of the support web W. The pressing roller 30 and the pressing roller 32 convey the support web W along the travelling direction ‘a’ while pressing the support web W toward the coating bar 2.

It is preferable to set the pressure with which the pressing roller 30 and the pressing roller 32 press the support web W, so that a wrap angle θ, which is the angle at which the support web W is rolled over the coating bar 2, is 1 to 30°.

The function of the coating apparatus 100 will be described below.

The support web W is retained so that the grained surface Sg faces downward and is conveyed along the travelling direction ‘a’ by the pressing roller 30 and the pressing roller 32.

When the support web W passes above the coating liquid-discharging nozzle 10, plate-making layer-forming liquid discharged upward from the coating liquid-discharging nozzle 10 adheres to the grained surface Sg across the entire width of the support web W.

A layer of plate-making layer-forming liquid adhering to the grained surface Sg is adjusted to a predetermined thickness by the coating bar 2. The coating thickness of the plate-making layer-forming liquid can be controlled by controlling the rotational direction and rotational speed of the coating bar 2, or by controlling the amount of the plate-making layer-forming liquid discharged from the coating liquid-discharging nozzle 10.

Because the coating bar 2 travels in the direction opposite to the travelling direction ‘a’ of the support web W, a large portion of excessive plate-making layer-forming liquid is scraped off upstream, flows down toward the base 20 along the inclined surface 8B of the upstream weir member 8, and is collected through the first drainage tube 20C.

However, a portion of the excessive plate-making layer-forming liquid adheres to the surface of the coating bar 2, is carried toward the fulcrum 4, and is carried downstream from the coating bar 2 after passing through a gap between the coating bar 2 and the fulcrum 4. Because the plate-making layer-forming liquid forms a thin film on the downstream surface of the coating bar 2, the plate-making layer-forming liquid is in a state in which a solvent component thereof readily evaporate so that a solid component thereof precipitates out.

However, the plate-making layer-forming liquid supplied to the coating liquid reservoir 14 from the second drainage tube 20B overflows upward from the downstream slit 12 to keep the downstream surface of the coating bar 2 wet, and to adhere to the downstream surface of the coating bar 2, and therefore, drying of the plate-making layer-forming liquid on the downstream surface of the coating bar 2 is prevented.

In the coating apparatus 100 pertaining to the first embodiment, the downstream surface of the coating bar 2 is constantly kept wet, and drying of the plate-making layer-forming liquid on the downstream surface of the coating bar 2 is prevented. Thus, evaporation of a solvent component in the plate-making layer-forming liquid and the precipitation of a solid content thereof downstream from the coating bar 2 are prevented.

Therefore, the solid content sticking to an undried plate-making layer and leading to defects such as thick coating is effectively prevented.

Also, because the plate-making layer-forming liquid itself is used as a drying-preventative liquid in the present invention, there are few periodic changes in the composition of the plate-making layer-forming liquid even when plate-making layer-forming liquid collected from the first drainage tube 20C and the second drainage tube 20D is circulated and reused in a continuous operation.

Moreover, because the coating liquid reservoir 14 is formed below the downstream slit 12, the plate-making layer-forming liquid can be overflowed from the downstream slit 12 in a constant flow, even when the flow of plate-making layer-forming liquid supplied fluctuates.

Second Embodiment

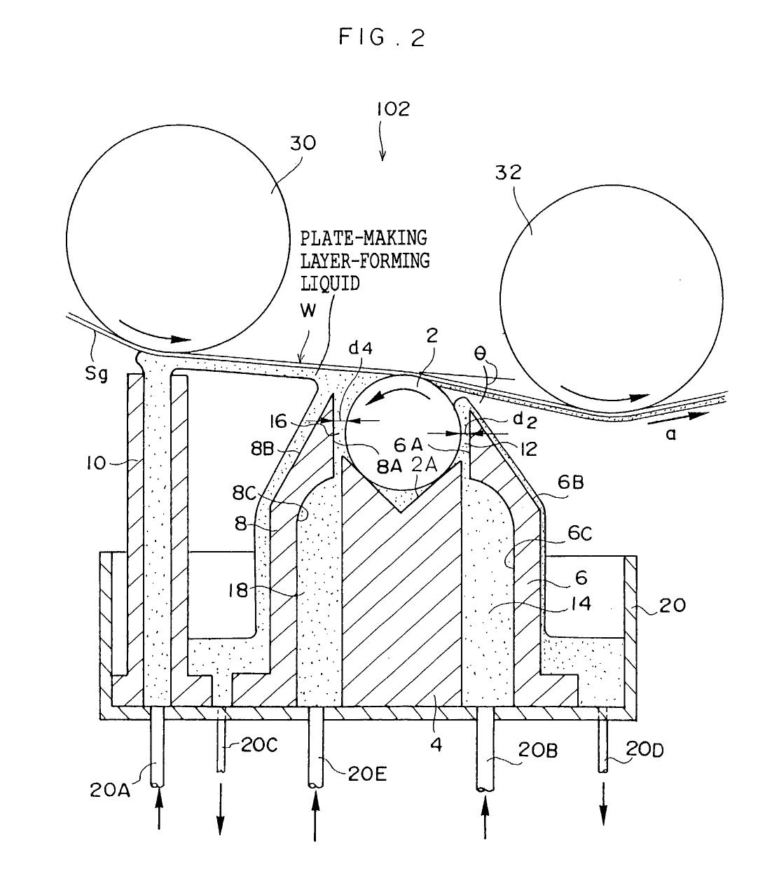

FIG. 2 shows the schematic structure of a different example of a coating apparatus of the present invention. In FIG. 2, reference numerals that are the same as those in FIG. 1 indicate elements that are the same as those shown in FIG. 1.

As shown in FIG. 2, in a coating apparatus 102 pertaining to a second embodiment, a third supply tube 20E for supplying the plate-making layer-forming liquid to the coating liquid reservoir 18 positioned upstream from the fulcrum 4 is disposed in the base 20. The width of the upstream slit 16 in the travelling direction ‘a’, i.e., a thickness d4, is preferably the same as the thickness d2 of the downstream slit 12.

Plate-making layer-forming liquid supplied from the third supply tube 20E passes through the coating liquid reservoir 18, overflows upward from the upstream slit 16, and is conveyed downstream by the coating bar 2 that rotates counter-clockwise in FIG. 2.

Plate-making layer-forming liquid overflowing upward from the upstream slit 16 adheres to the upstream side (with respect to the coating bar 2) of the grained surface Sg of the support web W.

Plate-making layer-forming liquid conveyed downstream by the coating bar 2 moves downstream through the gap between the coating bar 2 and the fulcrum 4 and wets the downstream surface of the coating bar 2.

With the exception of these points, the coating apparatus 102 has the same structure as the coating apparatus 100 pertaining to the first embodiment.

Therefore, the coating apparatus 102 not only has the same merit as that of the coating apparatus 100 but also can prevent the plate-making layer-forming liquid adhered to the grained surface Sg by the coating liquid-discharging nozzle 10 from drying before the thickness of a plate-making layer-forming liquid layer is adjusted by the coating bar 2, even when the coating liquid-discharging nozzle 10 is distant from the coating bar 2. In addition, drying of the plate-making layer-forming liquid film on the downstream surface of the coating bar 2 can be prevented from occurring, even when the amount of plate-making layer-forming liquid overflowing from the downstream slit 12 is reduced.

Moreover, the coating apparatus also has a virtue in that, by controlling the amount of plate-making layer-forming liquid overflowing from the upstream slit 16 as well as by controlling the amount of plate-making layer-forming liquid discharged from the coating liquid-discharging nozzle 10, the amount of plate-making layer-forming liquid adhering to the grained surface Sg of the support web W can be more widely controlled.

Third Embodiment

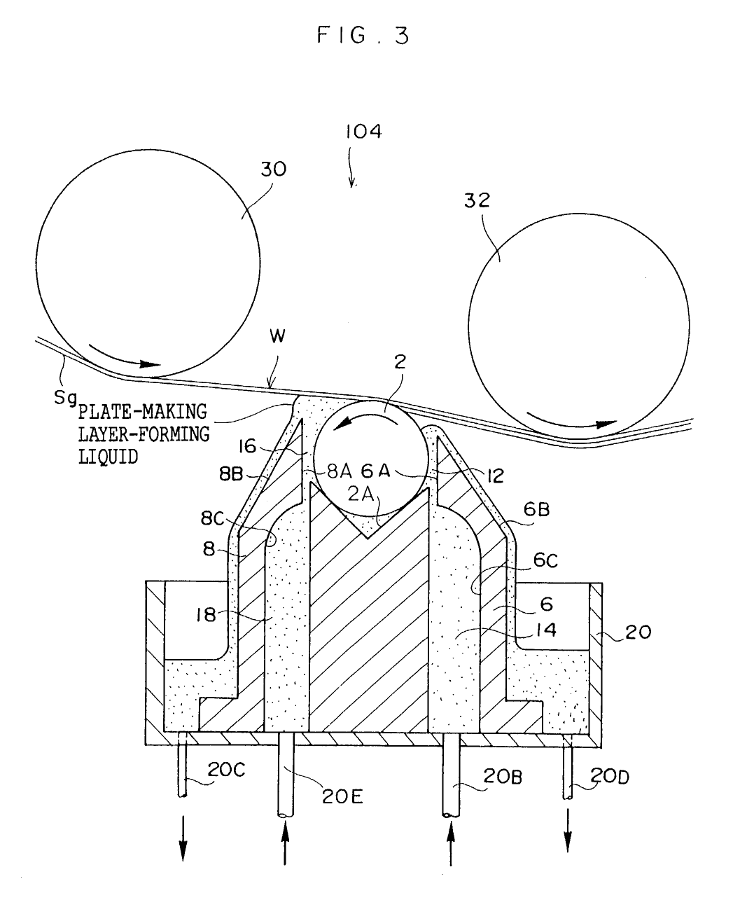

FIG. 3 shows an example of the coating apparatus of the present invention in which the upstream slit functions as the coating liquid-adhering device thereof.

As is clear from FIG. 3, a coating apparatus 104 pertaining to a third embodiment has a structure in which the coating liquid-discharging nozzle 10 and the first supply tube 20A have been removed from the coating apparatus pertaining to the second embodiment.

In the coating apparatus 104, plate-making layer-forming liquid supplied from the third supply tube 20E passes through the coating liquid reservoir 18, and a large portion of the plate-making layer-forming liquid overflows upward from the upstream slit 16 and adheres to the grained surface Sg of the support web W.

Plate-making layer-forming liquid adhering to the grained surface Sg is measured to a predetermined thickness by the coating bar 2.

At the same time, a portion of the plate-making layer-forming liquid supplied from the third supply tube 20E is conveyed downstream by the coating bar 2, passes through the gap between the coating bar 2 and the fulcrum 4, and wets the downstream surface of the coating bar 2.

Plate-making layer-forming liquid that passes through the coating liquid reservoir 14 from the second supply tube 20B and overflows upward from the downstream slit 12 also wets the downstream surface of the coating bar 2.

Therefore, because drying of the plate-making layer-forming liquid on the downstream surface of the coating bar 2 is also prevented in the coating apparatus 104, a solvent component in the plate-making layer-forming liquid evaporating and the solid substance therein precipitating and adhering to an undried plate-making layer to cause a defect such as thick coating can be prevented from occurring.

In addition to the virtue of the coating apparatus pertaining to the first embodiment, the coating apparatus pertaining to the third embodiment also has a virtue that the structure thereof can be simplified because it does not include the coating liquid-discharging nozzle 10 and the first supply tube 20A.

### EXAMPLES

### Examples 1 to 13 and Referential Example 1 and 2

One surface of an aluminium web was grained in accordance with a common method, and the grained surface was anodized to obtain a support web W.

Using the coating apparatus 100 shown in FIG. 1, a photosensitive layer-forming liquid, which is an example of the plate-making layer-forming liquid, was coated onto the support web W.

Coating conditions of the photosensitive layer-forming liquid were as follows.

| | | | |
|---|---|---|---|
| a. | Thickness of Support Web W | 0.3 | mm |
| b. | Travelling Speed of Support Web W | 100 | m/min. |
| c. | Ascending and Descending Speed of Coating | 3 | m/min. |
| | Bar 2 and Coating liquid-discharging nozzle 10 | | |
| d. | Distance between Coating Bar 2 and Coating | 35 | mm |
| | liquid-discharging nozzle 10 | | |
| e. | Diameter of Coating Bar 2 | 10 | mm |
| f. | Rotational Frequency of Coating Bar 2 | 50 | rpm |

| g. | Width of Downstream Slit | (as shown in | |
|---|---|---|---|
| | | Table 1) | |
| h. | Surface Tension of Photosensitive | 23 | nM/m |
| | Layer-Forming Liquid | | |
| i. | Coating Amount of Photosensitive Layer-Forming | 50 | cc/m² |
| | Liquid in Coating liquid discharging nozzle 10 | | |
| j. | Coating Amount of Photosensitive Layer-Forming | 20 | cc/m² |
| | Liquid after being Measured by Coating Bar 2 | | |

| | | |
|---|---|---|
| k. | Viscosity of Photosensitive Layer-Forming Liquid | (as shown in |
| | | Table 1) |

(as shown in Table 1)

The results are shown in Table 1. In Table 1, “◯” indicates that the photosensitive layer-forming liquid stably overflowed from the downstream slit 12 and that there was no drying of the photosensitive layer-forming liquid on the downstream surface of the coating bar 2, “Δ” indicates that there was no drying of the photosensitive layer-forming liquid on the downstream surface of the coating bar 2 even though overflow was somewhat unstable, and “×” indicates that overflow was unstable and there was drying of the photosensitive layer-forming liquid.

TABLE 1

| | Thickness of Downstream | | | | | |
|---|---|---|---|---|---|---|
| | Slit 12 | | Coating Liquid | | | |
| | Set Center | Difference | Viscosity (mPa/s) | | | |
| | Value (mm) | (mm) | 0.7 | 5 | 15 | 30 |
| Ref. Ex. 1 | 0.1 | ±0.05 | X | X | X | X |
| Example 1 | 0.2 | ±0.10 | ◯ | Δ | Δ | Δ |
| Example 2 | 0.2 | ±0.05 | ◯ | ◯ | Δ | Δ |
| Example 3 | 0.3 | ±0.20 | ◯ | ◯ | Δ | Δ |
| Example 4 | 0.3 | ±0.10 | ◯ | ◯ | ◯ | ◯ |
| Example 5 | 0.3 | ±0.05 | ◯ | ◯ | ◯ | ◯ |
| Example 6 | 0.4 | ±0.20 | ◯ | ◯ | ◯ | ◯ |
| Example 7 | 1.0 | ±0.20 | ◯ | ◯ | ◯ | ◯ |
| Example 8 | 2.0 | ±0.20 | ◯ | ◯ | ◯ | ◯ |
| Example 9 | 4.0 | ±0.20 | ◯ | ◯ | ◯ | ◯ |
| Example 10 | 6.0 | ±0.20 | ◯ | ◯ | ◯ | ◯ |
| Example 11 | 8.0 | ±0.20 | ◯ | ◯ | ◯ | ◯ |
| Example 12 | 10.0 | ±0.20 | Δ | ◯ | ◯ | ◯ |
| Example 13 | 12.0 | ±0.20 | Δ | Δ | ◯ | ◯ |
| Ref. Ex. 2 | 14.0 | ±0.20 | X | X | X | X |

As shown in Table 1, when the photosensitive layer-forming liquid was coated in accordance with the above-described coating conditions, as long as the thickness of the downstream slit 12 formed by the coating bar 2 and the downstream weir member 6 is 0.2 to 12 mm, the photosensitive layer-forming liquid overflowed from the downstream slit 12 and there was no drying of the photosensitive layer-forming liquid, and as long as the thickness of the downstream slit 12 was 0.3 to 10 mm, overflow was stable with the viscosity of the photosensitive layer-forming liquid being 0.7 to 30 mPa/s.

What is claimed is:

1. A coating apparatus for coating a coating liquid onto a continuously travelling belt-shaped body, the coating apparatus comprising:
a coating liquid-adhering device for adhering the coating liquid across an entire width of one surface of the belt-shaped body;
a coating thickness-adjusting device disposed downstream from the coating liquid-adhering device with respect to the travelling direction of the belt-shaped body, the coating thickness-adjusting device for adjusting a thickness of a layer of the coating liquid adhered to the belt-shaped body by the coating liquid-adhering device in a predetermined thickness; and
a drying-preventative device for preventing the coating liquid at the coating thickness-adjusting device from drying.

2. The coating apparatus of claim 1, wherein the coating thickness-adjusting device is a coating bar disposed downstream of the coating liquid adhering means with respect to the travelling direction of the belt-shaped body, and
the drying-preventative device is a downstream liquid-coating device for coating a drying-preventative liquid onto a downstream side of the coating bar with respect to the travelling direction of the belt-shaped body, the drying-preventative liquid for preventing drying of the coating liquid on a coating bar surface.

3. The coating apparatus of claim 2, wherein the drying-preventative liquid is the coating liquid.

4. The coating apparatus of claim 3, wherein the belt-shaped body is a support web for a planographic printing plate, and the coating liquid is a plate-making layer-forming liquid for forming a plate-making layer of the planographic printing plate.

5. The coating apparatus of claim 2, further comprising an upstream liquid-coating device for coating the drying-preventative liquid onto an upstream side of the coating bar with respect to the travelling direction of the belt-shaped body simultaneous with the coating of the coating liquid.

6. The coating apparatus of claim 3, further comprising an upstream liquid-coating device for coating the drying-preventative liquid onto an upstream side of the coating bar with respect to the travelling direction of the belt-shaped body simultaneous with the coating of the coating liquid.

7. The coating apparatus of claim 4, further comprising an upstream liquid-coating device for coating the drying-preventative liquid onto an upstream side of the coating bar with respect to the travelling direction of the belt-shaped body simultaneous with the coating of the coating liquid.

8. The coating apparatus of claim 4, further comprising a downstream weir member disposed downstream from the coating bar with respect to the travelling direction of the belt-shaped body so as to be parallel with and facing to the coating bar, wherein the downstream liquid-coating device is a downstream coating liquid flow path formed between the coating bar and the downstream weir member.

9. The coating apparatus of claim 7, further comprising a downstream weir member disposed downstream from the coating bar with respect to the travelling direction of the belt-shaped body so as to be parallel with and facing the coating bar, wherein the downstream liquid-coating device is a downstream coating liquid flow path formed between the coating bar and the downstream weir member.

10. The coating apparatus of claim 7, further comprising an upstream weir member disposed upstream from the coating bar with respect to the travelling direction of the belt-shaped body so as to be parallel with and facing to the coating bar, wherein the upstream liquid-coating device is an upstream coating liquid flow path formed between the coating bar and the upstream weir member.

11. The coating apparatus of claim 2, wherein the coating liquid-adhering device is a coating liquid-discharging nozzle for discharging the coating liquid toward the belt-shaped body, the coating liquid-discharging nozzle opening toward a travelling surface that is a travelling path of the belt-shaped body.

12. The coating apparatus of claim 5, wherein the upstream liquid-coating device also functions as a coating liquid-adhering device.

13. The coating apparatus of claim 8, wherein a gap between the downstream weir member and the coating bar is 0.2 to 12 mm.

14. The coating apparatus of claim 9, wherein a gap between the downstream weir member and the coating bar is 0.2 to 12 mm.

15. The coating apparatus of claim 10, wherein a gap between the upstream weir member and the coating bar is 0.2 to 12 mm.

16. The coating apparatus of claim 13, wherein the difference between a largest portion and a smallest portion of the gap between the downstream weir member and the coating bar is 0.05 mm or less.

17. The coating apparatus of claim 14, wherein the difference between a largest portion and a smallest portion of the gap between the downstream weir member and the coating bar is 0.05 mm or less.

18. The coating apparatus of claim 15, wherein the difference between a largest portion and a smallest portion of the gap between the upstream weir member and the coating bar is 0.05 mm or less.

19. A coating method for coating a coating liquid onto a continuously travelling belt-shaped body, the method comprising the steps of:
adhering the coating liquid onto the belt-shaped body by a coating liquid-adhering device;
adjusting by a coating thickness-adjusting device the thickness of a layer of the coating liquid adhered to the belt-shaped body by the coating liquid-adhering device to a predetermined thickness in a portion of the belt-shaped body downstream from the coating liquid-adhering device; and
simultaneous with the adjusting step, coating a drying-preventative liquid on the belt-shaped body with a drying preventative device at a downstream side of the coating liquid-adhering device with respect to the travelling direction of the belt-shaped body, the drying-preventative liquid preventing the coating liquid from drying at the coating thickness-adjusting device.

20. The coating method for coating a coating liquid of claim 19, wherein
the coating thickness-adjusting device is a coating bar that is disposed downstream of the coating liquid adhering means with respect to the travelling direction of the belt-shaped body, and
the drying-preventative device is a downstream liquid-coating device for coating a drying-preventative liquid onto a downstream side of the coating bar with respect to the travelling direction of the belt-shaped body.

21. The coating method of claim 20, wherein the drying-preventative liquid is the coating liquid.

22. The coating method of claim 21, wherein the belt-shaped body is a support web for a planographic printing plate, and the coating liquid is a plate-making layer-forming liquid for forming a plate-making layer of the planographic printing plate.
